(19) United States
(12) Patent Application Publication
(10) Pub. No.: US 2008/0139374 A1
(43) Pub. Date: Jun. 12, 2008

(54) Testing Apparatus and Method

(75) Inventor: James Dominic LeFeuvre, Yeovil (GB)

Correspondence Address: GREENLEE WINNER AND SULLIVAN P C, 4875 PEARL EAST CIRCLE, SUITE 200, BOULDER, CO, 80301, US

(73) Assignee: HONEYWELL NORMALAIR-GARRETT (HOLDINGS) LIMITED, YEOVIL (GB)

(21) Appl. No.: 11/832,917

(22) Filed: Aug. 2, 2007

(30) Foreign Application Priority Data
Aug. 4, 2006 (GB) 0615511.3

(51) Int. Cl. B04B 9/14; G01V 7/00

(52) U.S. Cl. 494/10; 73/382 G

(57) ABSTRACT

Apparatus for testing an article under a prevailing force of up to a number of times the gravitational force G, the apparatus including a driving device for imparting vibration to the article, the driving device including an element for connection to the article, the element being operable in a direction which is subject to at least a component of the prevailing force, wherein there is provided a balancing member mounted so as to be subject to at least the component of the prevailing force, the balancing member being connected to the element so as to apply to it a force in opposition to the prevailing force component thereon.

### CROSS-REFERENCE TO RELATED APPLICATIONS

This application claims priority under 35 USC 119(a)-(d) to United Kingdom Patent Application No. GB 0615511.3 filed on Aug. 4, 2006, which is incorporated by reference in its entirety herein.

### BACKGROUND TO THE INVENTION

This invention relates to the testing of articles such as components or assemblies of components (all herein referred to as “articles”) by subjecting an article under test to vibration at the same time as to forces of up to a number of times the gravitational force G.

The invention has application in the aerospace field, where an article to be used in aircraft, for example constituting or forming part of equipment used in an aircraft, may be required to be tested under such conditions. An aircraft, particularly a military aircraft, can, when maneuvering, create forces of a number of times the gravitational force “G” on everything which forms part of or is carried by the aircraft. Under certain conditions, substantial vibration can be created, and therefore it is necessary for the aircraft's equipment to be tested under conditions of high G forces and superimposed vibration.

For the purpose of testing articles, operational conditions of high G forces can be simulated by use of a centrifuge. The article under test can be mounted on a load-carrying part of the centrifuge, the centrifuge being operated at a speed to produce the required G force on the article. Vibration can additionally be applied to the article and superimposed on the G force by mounting a suitable actuator, e.g. an electro-mechanical actuator, on the load-carrying part of the centrifuge and connecting it to the article under test.

A disadvantage of such testing is that the forces produced by the centrifuge can interfere with the correct operation of the actuator which applies the vibratory forces to the article under test. In the case of an electromechanical vibratory actuator having an element such as a driving element or an output element movable in a direction in which the G force or a component thereof is effective, the element can become displaced from its normal rest position. Then the relationship between the output of the actuator and the electrical signal which drives the actuator becomes distorted so the article under test is not subject to the required vibration test conditions. It is broadly the object of the present invention to address this disadvantage.

### SUMMARY OF THE INVENTION

According to one aspect of the present invention, we provide apparatus for testing an article under a prevailing force of up to a number of times the gravitational force G, the apparatus including a driving device for imparting vibration to the article, the driving device including an element for connection to the article, the element being operable in a direction which is subject to at least a component of the prevailing force, wherein there is provided a balancing member mounted so as to be subject to at least the component of the prevailing force, the balancing member being connected to the element so as to apply to it a force in opposition to the prevailing force component thereon.

In principle, therefore, the invention utilises a balancing member which is arranged to be subject to at least a component of the prevailing high G force to which the driving device is subjected, and to apply to an element, such as an output element, of the driving device a force in opposition to the G force component which acts thereon. Thereby, the driving device is relieved of at least part of the effect of the G force thereon, and is able to apply the vibration to the article under test in the required manner.

The balancing member may be connected to the element of the driving device by connecting means including a lever having a fulcrum between positions where the balancing member is connected to the lever and where the element of the driving device is connected to the lever.

Preferably the mass of the balancing member, and the geometry of the lever, are such that substantially the entire prevailing force acting on the element is balanced by the force exerted by the balancing member thereon. However, there may be certain cases where less than complete, or even excess, balancing of the prevailing force is required, and this would be within the scope of the present invention.

Apparatus in accordance with the invention may be mounted on a load-carrying part of a centrifuge, which according to its speed of rotation provides a prevailing force of the required magnitude on the article to be tested.

Apparatus in accordance with the invention may be mounted on the load-carrying part in such a way as to be able to align with the resultant of the force created on the apparatus by the centrifuge and that acting on the apparatus due to gravity. By way of example, and as described hereafter, the apparatus may be pivotably mounted on the load-carrying part of the centrifuge.

The driving device, for imparting vibration to the article, may comprise an electromechanical vibrational actuator, e.g. of the moving coil type. Such an actuator may have an output element which is connected directly or indirectly to a support means on which the article under test can be carried, the balancing member being connected also to the output element of the actuator so as to oppose the force thereon resulting from operation of the centrifuge.

A resilient element or elements may be provided in the connecting means by which the balancing member is connected to the element of the driving means, so that the driving means is decoupled from the balancing member in respect of the vibration imparted by the driving means.

According to another aspect of the invention, we provide a method of testing an article by subjecting it to a prevailing force of up to a number of times the gravitational force, and additionally to vibration, characterised in that a balancing force is applied, in opposition to the prevailing force or a component thereof, to an element of a driving means which applied the vibration to the article.

Preferably the balancing force is applied by a balancing member, arranged so as to be subject to at least a component of the prevailing force, and connected to the element of the driving means in such a way as to apply to it a force in opposition to the prevailing force.

### BRIEF DESCRIPTION OF DRAWINGS

The invention will now be described by way of example with reference to the accompanying drawings of which:

FIG. 1 diagrammatically illustrates an apparatus in accordance with the invention, in an operating condition.

FIG. 2 illustrates a similar apparatus, in an at-rest condition.

### DETAILED DESCRIPTION

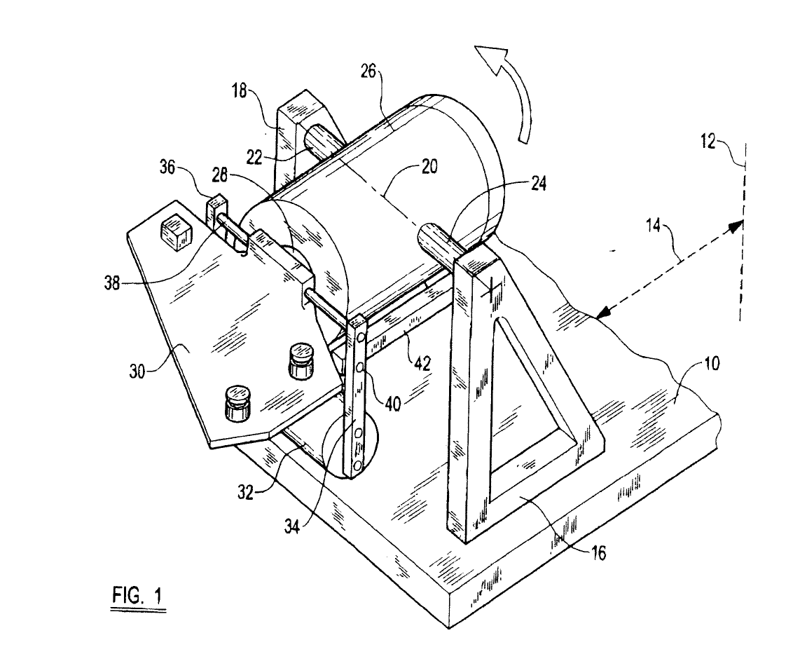

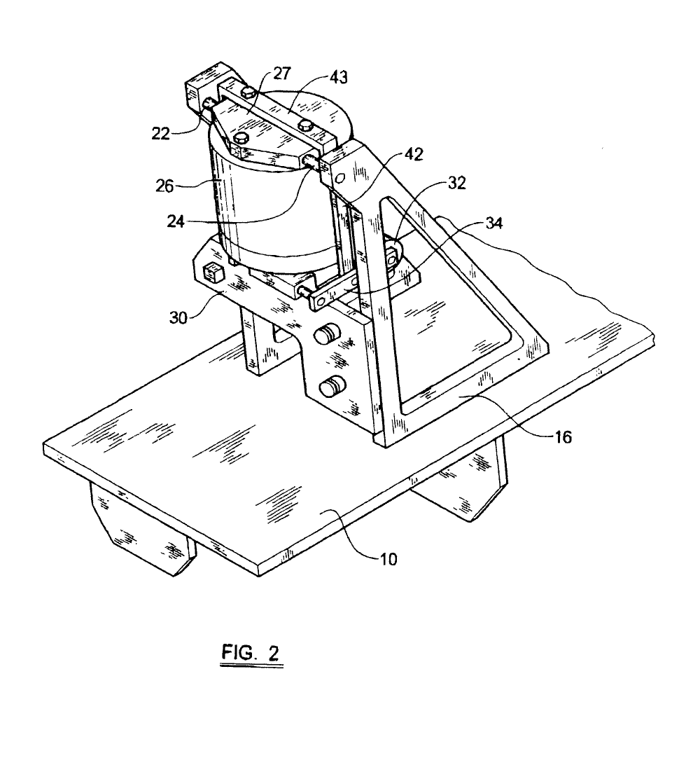

The apparatuses shown in FIGS. 1 and 2 are the same as one another in respect of their main components and principle of operation, differing only in respect of details of the shape and arrangement of such components. Therefore, the following description can be taken to refer to both figures of the drawings, with features of difference therebetween being mentioned where appropriate. The same reference numerals are used for corresponding parts.

The drawings show a load-carrying table 10 of a centrifuge. In a known manner, the centrifuge table 10 is carried by an arm mounted, at a distance indicated at 14 from the table 10, for rotation about an axis 12 shown in FIG. 1, in which this distance 14 is not shown to the scale of the drawing.

The load-carrying table 10 of the centrifuge carries two spaced upstanding brackets 16, 18 which support, for pivoting about an axis 20, opposed trunnions 22, 24 extending (in FIG. 1) from a body 26 of a vibrational actuator. In FIG. 2, trunnions 22, 24 are provided on a plate 27 to which the body 26 of the actuator is secured. The actuator may be of the electromechanical type, e.g. a moving-coil device, having an output element indicated at 28, connected to a movable armature within the actuator. However, the invention may utilise a driving device or actuator or of any suitable type.

The output element 28 of the vibrational actuator is connected to a support plate 30 on which may be mounted an article or articles under test.

The arrangement and geometry of the components above described, and in particular the position of the centre of gravity of components which are pivotable about axis 20, may be such that when the centrifuge is not operating the actuator assumes an orientation in which the support plate 30 depends downwardly from the actuator, generally beneath the axis 20, as shown in FIG. 2. When the centrifuge is operating, however, it aligns itself about the axis 20 in accordance with the resultant of the forces acting on it due to operation of the centrifuge and the force of gravity. The magnitude of such resultant force may be a number of times the gravitational force G, so a position at or approaching that shown in FIG. 1 is assumed.

In accordance with the invention, there is provided a balancing member 32 which in essence is a weight of suitable magnitude, carried by and held between corresponding end portions of spaced parallel lever elements 34, 36, part only of the latter lever element being visible. Opposite end parts of the lever elements 34, 36 are connected to a transverse shaft 38 extending therebetween, and connected in its mid region to the output element 28 of the actuator or, as illustrated, the support member 30 in the vicinity of the output element 28. The lever elements 34, 36 are fulcrumed about respective pivots between their two ends, that of the lever element 34 being visible at 40. These pivots for the lever elements 34, 36 are carried by respective arms one of which is visible at 42, extending to connect to the body 26 of the actuator or possibly to the trunnions 22, 24 to be pivotable about the axis 20. In FIG. 2, the arms as 42 are arranged as respective parallel limbs of a generally U-shaped element joined by a portion 43 connected to the plate 27.

It will be apparent from the arrangement of the balancing member 32 and the lever elements 34, 36 that the effect of these components is to apply to the output element 28 of the actuator a force in opposition to the prevailing force operating thereon as the resultant of static gravity and the, potentially much higher, force due to the operation of the centrifuge. Thus the armature of the actuator is not displaced from its usual static rest position, so that its operation is not constrained or affected by the resultant force acting thereon, which might be several times the static gravitational force G. The arrangement of the balancing member 32, and lever elements 34, 36, may be such as to substantially exactly counterbalance the prevailing forces acting on the output element of the actuator, or a required percentage thereof.

Although not depicted in the illustration, the connection between the shaft 38 and the output element 28 of the actuator may be effected by way of a resilient element which, if selected to have a suitable degree of resilience, can mean that the operation of the vibrational actuator does not have to move the balancing weight 32 as well as the combined mass of the armature and output element of the actuator, together with the support member 30 and article(s) carried thereby. By virtue of this provision, the performance of the actuator is not degraded by the additional provision of the balancing member 32 and associated components. A resilient element or elements for this purpose may comprise one or more rubber bushes or the like, at a suitable point or points in the means including the levers 34, 36 which connect the balancing member 32 to the output element 28.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. Apparatus for testing an article under a prevailing force of up to a number of times the gravitational force G, the apparatus including a driving device for imparting vibration to the article, the driving device including an element for connection to the article, the element being operable in a direction which is subject to at least a component of the prevailing force, wherein there is provided a balancing member mounted so as to be subject to at least the component of the prevailing force, the balancing member being connected to the element so as to apply to it a force in opposition to the prevailing force component thereon.

2. Apparatus according to claim 1 wherein the balancing member is connected to the element of the driving device by a connecting linkage including a lever, the lever having first and second connections respectively to the balancing member and to the element of the driving device and a fulcrum between the first and second connections.

3. Apparatus according to claim 2 wherein the mass of the balancing member and the geometry of the connecting linkage are arranged such that substantially the entire prevailing force acting on the element is balanced by the force exerted by the balancing member.

4. Apparatus according to claim 1, mounted on a load-carrying part of a centrifuge.

5. Apparatus according to claim 4 wherein the apparatus is mounted on the load-carrying part of the centrifuge so as to be able to align with the resultant of the force created on the apparatus by the centrifuge and that acting on the apparatus due to gravity.

6. Apparatus according to claim 5 which is pivotally mounted on the load-carrying part of the centrifuge.

7. Apparatus according to claim 1 wherein the driving device comprises an electro-mechanical vibrational actuator.

8. Apparatus according to claim 7 wherein the actuator is of the moving coil type.

9. Apparatus according to claim 7 comprising a support for the article under test, to which an output element of the actuator is connected.

10. Apparatus according to claim 9 wherein the balancing member is connected to the output element of the actuator to oppose the prevailing force thereon.

11. Apparatus according to claim 2 wherein the connecting linkage includes at least one resilient element.

12. A method of testing an article by subjecting it to a prevailing force of up to a number of times the gravitational force, and additionally to vibration, characterised in that a balancing force is applied, in opposition to the prevailing force or a component thereof, to an element of a driving means which applies the vibration to the article.

13. A method according to claim 12 wherein the balancing force is applied by a balancing member, arranged to be subject to at least the component of the prevailing force, and connected to the element of the driving means in such a way as to apply to it a force opposing the prevailing force.
